(19) United States
(12) Patent Application Publication
(10) Pub. No.: US 2023/0064791 A1
(43) Pub. Date: Mar. 2, 2023

(54) SYSTEM, APPARATUS, AND METHOD FOR PROVIDING AN UNEVEN ADHESIVE LAYER

(71) Applicant: Global Film Source LLC, Edison, NJ (US)

(72) Inventor: Johannes Blok, Buffalo, NY (US)

(21) Appl. No.: 17/462,490

(22) Filed: Aug. 31, 2021

(51) Int. Cl. B32B 37/12; C09J 5/00; C09J 7/10; C09J 7/38

(52) U.S. Cl. CPC B32B 37/12; C09J 5/00; C09J 7/10; C09J 7/38; B32B 2471/02; C09J 2203/314

(57) ABSTRACT

A method for protecting a surface portion is disclosed. The method includes providing an adhesive layer on a surface of a protective layer, the adhesive layer having a first surface that is adhered to the surface of the protective layer, providing an uneven second surface to the adhesive layer, the uneven second surface disposed on an opposite side of the adhesive layer as the first surface, and attaching the protective layer to the surface portion by attaching the uneven second surface of the adhesive layer to an uneven surface of the surface portion.

### TECHNICAL FIELD

The present disclosure generally relates to a system, apparatus, and method for providing a layer, and more particularly to a system, apparatus, and method for providing an uneven adhesive layer.

### BACKGROUND

Surface protection films are typically used to protect surfaces from dirt, scratches, and other damage. These types of films are usually produced by applying a layer of adhesive to a film or paper substrate. In conventional surface protection films, the adhesive layer is typically smooth, which provides full contact with flat and smooth surfaces to be protected.

However, a smooth adhesive layer does not provide good surface contact with uneven surfaces such as fabrics and carpets. To account for limited contact area and to provide adequate holding power, an aggressiveness or tackiness of the adhesive is typically increased to keep the film in place on the uneven surface to be protected.

Using more aggressive adhesives, however, typically makes surface protection films more expensive. Also, using more aggressive adhesive often increases a chance of adhesive transfer, in which a portion of the adhesive bonds to and can remain permanently attached to the surface to be protected, which is generally undesirable.

The exemplary disclosed system, apparatus, and method of the present disclosure are directed to overcoming one or more of the shortcomings set forth above and/or other deficiencies in existing technology.

### SUMMARY OF THE DISCLOSURE

In one exemplary aspect, the present disclosure is directed to method for protecting a surface portion. The method includes providing an adhesive layer on a surface of a protective layer, the adhesive layer having a first surface that is adhered to the surface of the protective layer, providing an uneven second surface to the adhesive layer, the uneven second surface disposed on an opposite side of the adhesive layer as the first surface, and attaching the protective layer to the surface portion by attaching the uneven second surface of the adhesive layer to an uneven surface of the surface portion.

In another aspect, the present disclosure is directed to an apparatus for protecting a surface portion having an uneven surface. The apparatus includes a protective layer and an adhesive layer having a first surface that is permanently adhered to a base surface of the protective layer. A second surface of the adhesive layer, which is disposed on an opposite side of the adhesive layer as the first surface, is an uneven adhesive surface configured to removably attach to the uneven surface of the surface portion. The adhesive layer is formed from adhesive material having a surface tension that is greater than a surface energy of the base surface of the protective layer.

### BRIEF DESCRIPTION OF THE DRAWINGS

FIG. 1 is a cross-sectional view of at least some exemplary embodiments of the present invention;

FIG. 2 is a cross-sectional view of at least some exemplary embodiments of the present invention;

FIG. 3 is a cross-sectional view of at least some exemplary embodiments of the present invention;

FIG. 4 is a cross-sectional view of at least some exemplary embodiments of the present invention;

FIG. 5 is a cross-sectional view of at least some exemplary embodiments of the present invention;

FIG. 6 is a bottom view of at least some exemplary embodiments of the present invention;

FIG. 7 is a bottom view of at least some exemplary embodiments of the present invention;

FIG. 8 is a cross-sectional view of at least some exemplary embodiments of the present invention;

FIG. 9 is a side view of at least some exemplary embodiments of the present invention;

FIG. 10 is a cross-sectional view of at least some exemplary embodiments of the present invention;

FIG. 11 is a cross-sectional view of at least some exemplary embodiments of the present invention;

FIG. 12 is a side view of at least some exemplary embodiments of the present invention;

FIG. 13 is a side view of at least some exemplary embodiments of the present invention; and

FIG. 14 illustrates an exemplary process of at least some exemplary embodiments of the present disclosure.

### DETAILED DESCRIPTION AND INDUSTRIAL APPLICABILITY

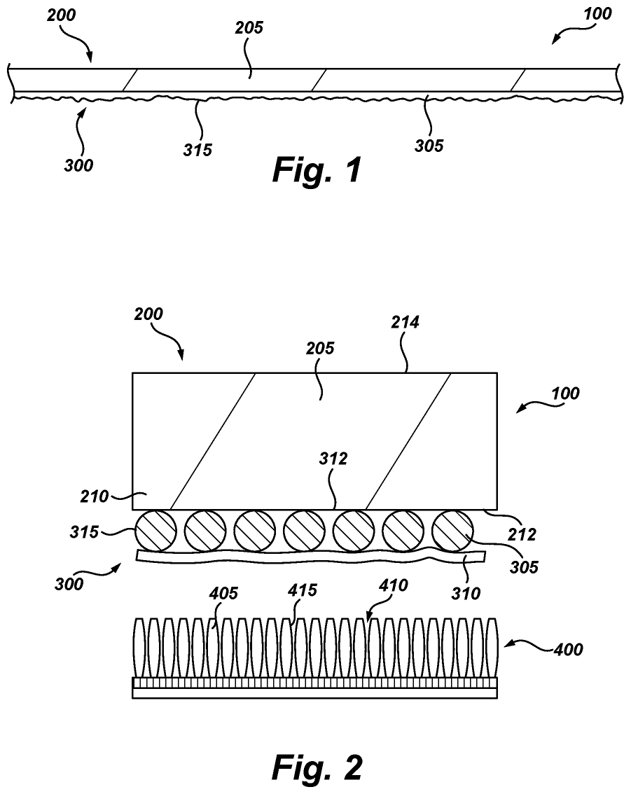

FIGS. 1 and 2 illustrate an exemplary embodiment of the exemplary disclosed system, apparatus, and method. Assembly 100 may be an assembly for protecting a surface. For example, the exemplary disclosed system, apparatus, and method may be used for protecting an uneven surface and/or a fragile surface.

As illustrated in FIGS. 1 and 2, assembly 100 may include a protective assembly 200 and an adhesive assembly 300. Adhesive assembly 300 may be attached to protective assembly 200.

Protective assembly 200 may be any suitable assembly for protecting a surface. Protective assembly 200 may include one or more film layers. For example, protective assembly 200 may include a protective layer such as a film layer 205 or a plurality of layers that may be similar to film layer 205. Film layer 205 may be formed from any suitable fabric, plastic material, paper, composite material, and/or any other suitable material for protecting a surface. For example, film layer 205 may be formed from polyethylene, polypropylene, vinyl, and/or polyvinyl material. Film layer 205 may be formed from any suitable natural or synthetic fiber material. For example, film layer 205 may be formed from cotton, polyester, nylon, acrylic, rayon, blends of these exemplary materials, and/or any other suitable fiber fabric or material.

A film surface portion 210 of film layer 205 may include adhesion-increasing material that may be disposed on a base surface (e.g., a film surface 212) of film layer 205 and/or may be infused into, impregnated into, and/or infiltrated into the material of film surface portion 210. For example, film surface portion 210 may be a surface portion of film layer 205 that has been exposed to or undergone a treatment for enhancing or increasing adhesion. Film surface portion 210 may be treated to increase adhesion with adhesive assembly 300. The exemplary treatment may be an adhesion-enhancing treatment. The exemplary treatment may be a plasma treatment (e.g., in-line plasma treatment), a corona treatment, a flame treatment (e.g., pyrosil flame treatment), and/or any other suitable treatment for enhancing adhesion and bonding. Film surface portion 210 may thereby adhere (e.g., permanently adhere) film layer 205 to adhesive assembly 300 for example as illustrated in FIGS. 1 and 2. Film surface portion 210 may thereby provide a fused, fixed, or substantially permanent attachment between film layer 205 and adhesive assembly 300 so that film layer 205 does not detach or separate from adhesive assembly 300 during use of assembly 100 (e.g., when an opposite side of adhesive assembly 300 is being removably adhered to a surface to be protected for example as described herein). In at least some exemplary embodiments, a protective surface such as an opposite surface 214 of film layer 205 may be untreated (e.g., not treated to enhance or increase adhesion).

Adhesive assembly 300 may include an adhesive layer 305. In at least some exemplary embodiments, adhesive assembly 300 may also include a cover layer 310 that may be disposed on adhesive layer 305.

Cover layer 310 may be formed from material similar to film layer 205 or any other suitable material for covering adhesive layer 305. Cover layer 310 may have untreated surfaces (e.g., surfaces that may not be treated to enhance or increase adhesion). Cover layer 310 may removably cover (e.g., be removably attached to) adhesive layer 305. For example, cover layer 310 may be removably attached to adhesive layer 305 prior to use of assembly 100 (e.g., before assembly 100 may be used to cover or protect a surface and/or before any other exemplary use of assembly 100). For example, cover layer 310 may cover adhesive layer 305 when assembly 100 is transported, stored, and/or not in use (e.g., prior to use).

Adhesive layer 305 may be formed from any suitable adhesive material for adhering (e.g., removably adhering) to a surface to be protected and also for substantially permanently adhering to film surface portion 210. An adhesive base surface 312 of adhesive layer 305 may be attached to film surface 212 of film layer 205. For example, adhesive layer 305 may be formed from acrylic adhesive (e.g., water-based or solvent-based acrylic adhesive), natural adhesive such as rubber adhesive (e.g., water-based or solvent-based rubber adhesive), pressure-sensitive adhesive (e.g., acrylic-based pressure-sensitive adhesive), hotmelt adhesive, and/or any other suitable adhesive.

Adhesive layer 305 may be formed from any suitable adhesive having a relatively high surface tension. For example, adhesive layer 305 may be formed from adhesive having a surface tension that is greater than a surface energy (e.g., a wet surface tension) of film surface 212 so that adhesive layer may be partially de-wetted (e.g., and/or foaming or bubbling of adhesive layer 305 may occur) when applied to film surface 212. As illustrated for example in FIG. 2, adhesive layer 305 may form beads after adhesive layer 305 is applied to film surface 212. For example, adhesive layer 305 may be partially or substantially de-wetted when disposed at film surface 212. For example, adhesive layer 305 may not be spread or wetted (e.g., substantially entirely spread or wetted) over film surface 212. As illustrated for example in FIG. 2, beads of adhesive layer 305 may form any suitable contact angle with film surface 212. Additives may also be added to the adhesive material forming adhesive layer 305 to affect (e.g., increase) surface tension.

In at least some exemplary embodiments, adhesive layer 305 may be formed from adhesive having a surface tension that is greater than or equal to about 20 dynes/cm (e.g., or millinewton per meter or mN/m), greater than or equal to about 30 dynes/cm, greater than or equal to about 40 dynes/cm, or greater than or equal to about 50 dynes/cm (e.g., at a temperature of about 20 degrees Celsius). Adhesive layer 305 may be formed from adhesive material having a surface tension that is between about 42 dynes/cm and about 46 dynes/cm, or between about 44 dynes/cm and about 46 dynes/cm (e.g., at a temperature of about 20 degrees Celsius). In at least some exemplary embodiments, adhesive layer 305 may be formed from an adhesive material having a surface tension greater or equal to 43 dynes/cm and being applied to a low density polyethylene surface that is treated to a surface tension of 42 dynes/cm (e.g., at a temperature of about 20 degrees Celsius). Adhesive layer 305 may have a surface tension of between about 1 and about 4 dynes/cm greater than the wet surface tension of polymers or plastics. Adhesive layer 305 may have a surface tension greater than or equal to a surface energy (e.g., a wet surface tension) of polyethylene, polypropylene, vinyl, polyvinyl, cotton, polyester, nylon, acrylic, or rayon. Adhesive layer 305 may be formed from adhesive having a surface tension that is between about 30 dynes/cm and about 40 dynes/cm, between about 40 dynes/cm and about 50 dynes/cm, or between about 50 dynes/cm and about 60 dynes/cm (e.g., at a temperature of about 20 degrees Celsius). Adhesive layer 305 may be formed from adhesive material having a surface tension that is between about 1 dyne/cm and about 10 dynes/cm greater than a wet surface tension of film layer 205, between about 1 dyne/cm and about 6 dynes/cm greater than a wet surface tension of film layer 205, between about 1 dyne/cm and about 4 dynes/cm greater than a wet surface tension of film layer 205, or any suitable amount greater than a wet surface tension of film layer 205.

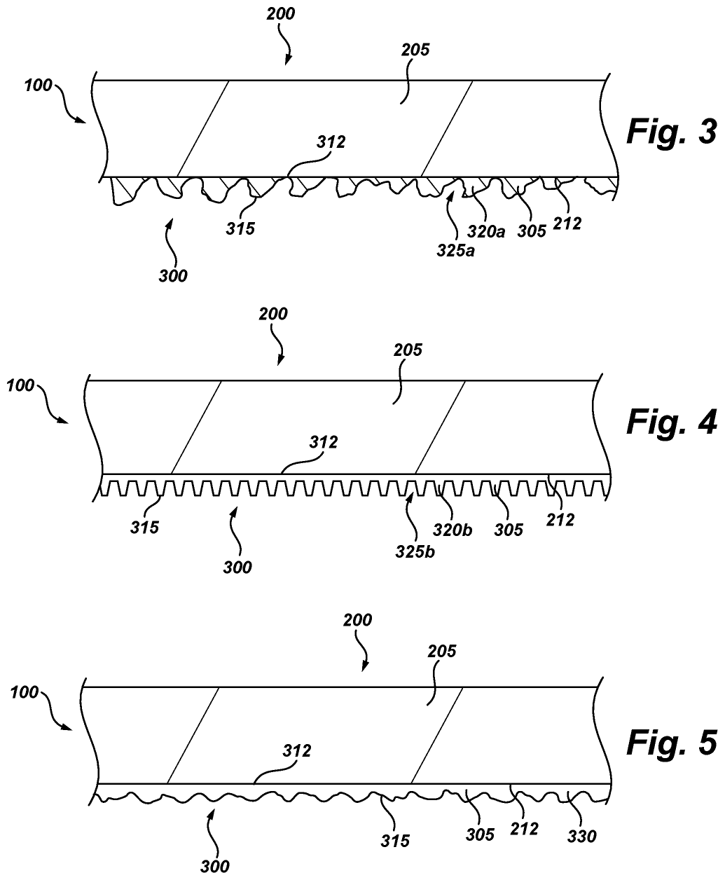

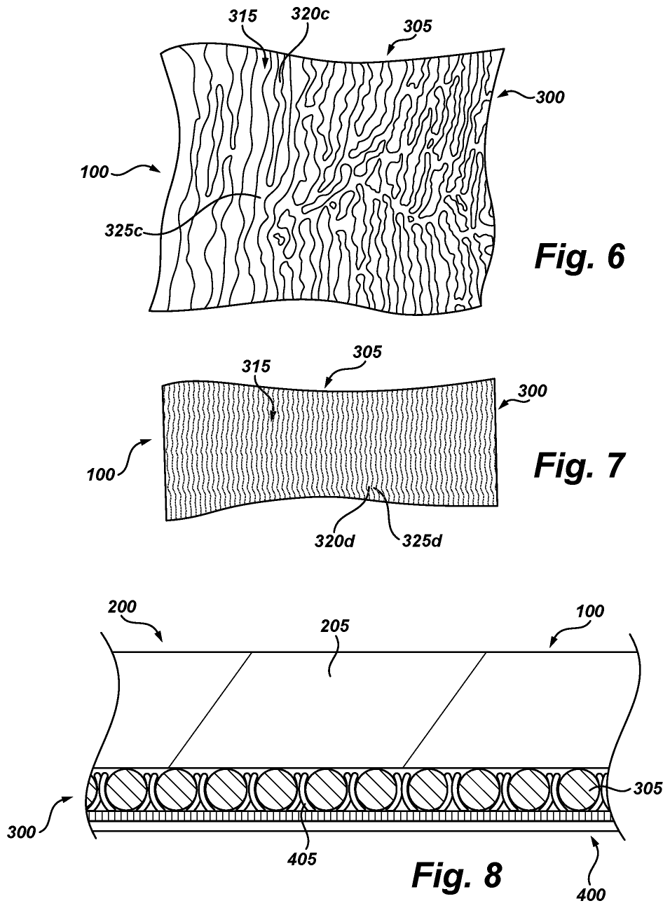

As illustrated for example in FIGS. 2-7, an adhesive surface 315 of adhesive layer 305 may be any suitable uneven surface. For example, adhesive surface 315 may be an irregular surface. Adhesive surface 315 may be a textured surface. Adhesive surface 315 may include a plurality of bulbous portions (e.g., may be a bubbly surface). In at least some exemplary embodiments, adhesive surface 315 may be a rough or bumpy surface. In at least some exemplary embodiments and as illustrated in FIG. 2, adhesive surface 315 may include surfaces of beads formed in adhesive layer 305 for example as described above. Adhesive surface 315 may be formed with a plurality of protrusions and recesses. In at least some exemplary embodiments and as illustrated in FIG. 3, adhesive surface 315 may be irregularly formed on film surface 212 and may include irregularly formed protrusions 320a and recesses 325a. In at least some exemplary embodiments and as illustrated in FIG. 4, adhesive surface 315 may include a patterned uneven surface formed on film surface 212 and may include patterned protrusions 320b and recesses 325b. In at least some exemplary embodiments and as illustrated in FIG. 5, adhesive surface 315 may include an irregular surface formed on a base portion 330 disposed on film surface 212. In at least some exemplary embodiments and as illustrated in the exemplary bottom view of FIG. 6, adhesive surface 315 may include an irregularly formed plurality of protrusions 320c and recesses 325c that may form an irregular surface such as a contoured or textured surface. In at least some exemplary embodiments and as illustrated in the exemplary bottom view of FIG. 7, adhesive surface 315 may include an irregularly formed plurality of linear protrusions 320d and recesses 325d. Increasing an amount of recesses and protrusions provided in adhesive layer 305 may increase a surface area of adhesive surface 315.

Adhesive layer 305 for example as illustrated in the exemplary embodiments of FIGS. 2-7 may be formed by any suitable technique. For example, adhesive layer 305 may be formed based on using adhesive material having relatively high surface tension for example as described above.

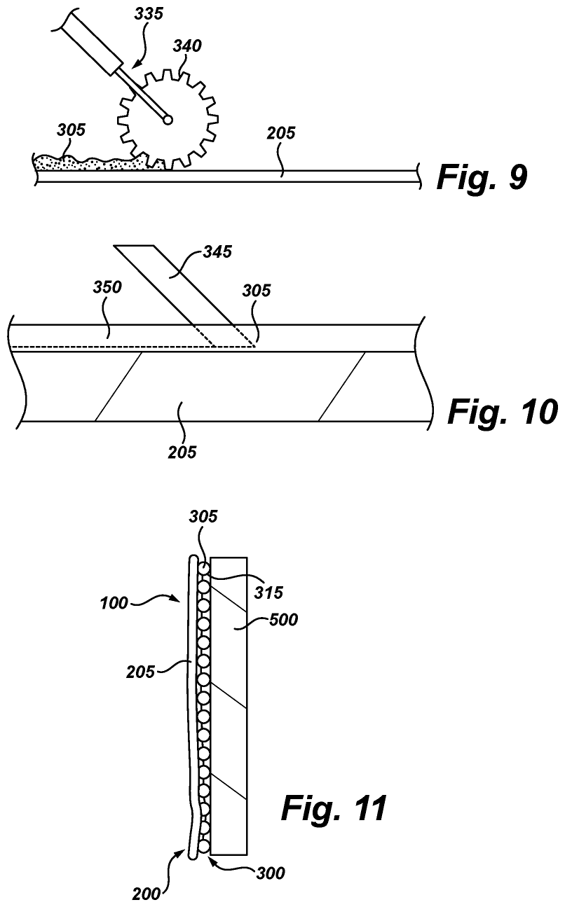

In at least some exemplary embodiments and as illustrated in FIG. 9, adhesive layer 305 may be formed using a spreading device 335. Spreading device 335 may be any suitable coating apparatus (e.g., coater). Spreading device 335 may be any suitable device for applying material of adhesive layer 305 to film surface 212 of film layer 205 such as, for example, a roller, a brush, a sprayer, or any other suitable spreading device. For example, spreading device 335 may be a gravure roller (e.g., a textured or patterned gravure roller) having an uneven roller surface 340 that may unevenly apply material of adhesive layer 305 to film surface 212 to produce adhesive surface 315 for example as illustrated in FIGS. 2-7. For example as spreading device 335 applies material of adhesive layer 305 to film surface 212, substantially dry portions or spots may be present on spreading device 335 (e.g., on uneven roller surface 340) to produce an uneven adhesive surface 315. Also for example, material of adhesive layer 305 may be applied so that an entirety of film surface 212 may not be covered with adhesive layer 305 (e.g., substantially uneven spots may be present on film surface 212, which may form an uneven adhesive surface 315). Also for example, spreading device 335 may be a brush including uneven bristles, a sprayer configured to apply material unevenly to a surface, and/or any other suitable device for applying material unevenly.

In at least some exemplary embodiments, adhesive material may be applied to film surface 212 via a narrow die provided in spreading device 335 that may be a slot coating apparatus. In another exemplary embodiment, adhesive material may be applied to spreading device 335 that may be an application roller, the adhesive material being transferred to film surface 212 and subsequently metered off via a wire wound metering rod of spreading device 335 (e.g., including a Mayer rod), thereby forming adhesive layer 305.

In at least some exemplary embodiments, adhesive layer 305 may be applied smoothly (e.g., initially smoothly) onto film surface 212 of film layer 205. In at least some exemplary embodiments when adhesive layer 305 may be formulated such that the adhesive material of adhesive layer 305 has a higher surface tension than a wet surface tension of film layer 205, some beading will occur before adhesive layer 305 dries, thereby creating an uneven adhesive surface 315 (e.g., a beaded or bumpy adhesive surface 315) for example as illustrated in FIG. 2.

In at least some exemplary embodiments and as illustrated in FIG. 10, adhesive layer 305 may be formed using a cutting device 345. Cutting device 345 may include any suitable device or devices for removing material from adhesive layer 305 formed on film surface 212 of film layer 205 such as, for example, one or more chisels, gouges, fluteroni tools, carving tools, and/or any other suitable carving or material-removal tool. For example, cutting device 345 may be any suitable device for providing one or more recesses (e.g., a recess 350) in adhesive layer 305. Recess 350 may be similar to recesses 325a, 325b, 325c, and/or 325d. Recess 350 may be a groove. Cutting device 345 may provide one or more grooves or a pattern of recesses in adhesive layer 305. Cutting device 345 may make one or more recesses 350 in adhesive layer 305 with protrusions formed between recesses 350 that may be similar to protrusions 320a, 320b, 320c, and/or 320d. For example, cutting device 345 may produce adhesive surface 315 for example as illustrated in FIGS. 3-7.

As illustrated in FIGS. 2 and 8, assembly 100 may be removably attached to a surface portion to be protected such as a surface portion 400. Surface portion 400 may include a plurality of surface protrusions 405. Surface protrusions 405 may include for example fabric or textiles protrusions, yarn portions, thread portions, fibers, tufts, plastic protrusions, bristles, and/or any other suitable type of protrusions. Surface protrusions 405 (e.g., and/or other portions of surface portion 400) may be formed from any suitable type of material such as wool fibers, polypropylene, olefin, woven nylon, polyester, acrylic, and/or any other suitable type of material (e.g., textile, plastic, and/or any other suitable material for a surface portion). Surface protrusions 405 may also be integral protrusions of a plastic, wood, textile, and/or any other suitable surface. A plurality of surface recesses 410 may be formed between the plurality of surface protrusions 405. Surface protrusions 405 and surface recesses 410 may form uneven surface 415. As illustrated in FIGS. 2 and 8, uneven surface 415 may be an irregular surface. Uneven surface 415 may be a textured surface. Uneven surface 415 may be a rough or bumpy surface. In at least some exemplary embodiments in which surface portion 400 may be a surface portion of a rug or carpet, uneven surface 415 may be an irregular or textured surface formed by surface protrusions 405 that may be rug or carpet yarn or thread portions. Surface portion 400 may be an uneven surface of any suitable object such as, for example, a rug, a carpet, a piece of furniture, an uneven floor, uneven wall, or uneven ceiling surface (e.g., a popcorn ceiling), a vehicle interior or exterior surface, or any other suitable object having an uneven surface. In at least some exemplary embodiments, surface portion 400 may have a smooth or flat surface. In at least some exemplary embodiments, uneven surface 415 may be an untreated surface (e.g., not treated to enhance or increase adhesion).

As illustrated in FIG. 8, assembly 100 may be removably attached to surface portion 400. In at least some exemplary embodiments, assembly 100 may be removably attached to surface portion 400 after cover layer 310 has been removed from adhesive layer 305. When assembly 100 is removably attached to surface portion 400, adhesive surface 315 that may be an uneven surface may contact and adhere to (e.g., removably adhere to) uneven surface 415. For example, surface protrusions 405 may be deformed by contact with adhesive surface 315 that may be an uneven surface for example as illustrated in FIGS. 2-7. Adhesive surface 315 and uneven surface 415 may both be uneven surfaces, which may increase a surface area that is in contact and adhered. For example, the uneven surfaces of adhesive surface 315 and uneven surface 415 may increase an adhered surface area between adhesive surface 315 and uneven surface 415 relative to a case in which smooth surfaces are in contact. For example, surface protrusions 405 may be disposed between portions of adhesive layer 305 (e.g., beads or protrusions such as protrusions 320a, 320b, 320c, and/or 320d) when adhesive surface 315 and uneven surface 415 are in contact, which may increase an adhered surface area between adhesive surface 315 and uneven surface 415. Deformation of surface protrusions 405 within recesses (e.g., recesses 325a, 325b, 325c, and/or 325d) of adhesive layer 305 and/or against protrusions (e.g., protrusions 320a, 320b, 320c, and/or 320d) of adhesive layer 305 may also increase a surface area of adhered surfaces between adhesive surface 315 and uneven surface 415. The uneven surfaces of adhesive surface 315 and uneven surface 415 may thereby increase a surface area that may be adhered between adhesive surface 315 and uneven surface 415 when assembly 100 is attached (e.g., removably attached) to surface portion 400. In at least some exemplary embodiments, assembly 100 may be substantially permanently attached to surface portion 400.

In at least some exemplary embodiments, assembly 100 may be a removable attachment or a permanent attachment. For example, permanent attachments may be labels, instructions, or any other suitable application in which a substantially permanent bond may be utilized.

Because an adhered surface area between assembly 100 and surface portion 400 may be increased based on surface area contact between uneven surfaces of adhesive surface 315 and uneven surface 415 for example as described above, a less aggressive adhesive material may be used in forming adhesive layer 305 while still providing a desired peeling force (e.g., a force used for removing assembly 100 from surface portion 400). For example, as the surface area increases, an adhesive strength of adhesive material forming adhesive layer 305 may be decreased, while still providing a substantially overall equal peeling force. For example, as both the surface area and the adhesive strength may be proportional to the peeling force, increasing the surface area for example as described above may allow for an adhesive strength of material of adhesive layer 305 to be reduced while maintaining a substantially constant peeling force. Increasing an unevenness of adhesive surface 315 may increase a surface area of adhesive surface 315. Unevenness of adhesive surface 315 may be increased for example by increasing a height (e.g., and/or a number) of the exemplary disclosed protrusions of adhesive layer 305 and/or by increasing a depth (e.g., and/or a number) of the exemplary disclosed recesses of adhesive layer 305. Unevenness of adhesive surface 315 may be decreased for example by decreasing a height (e.g., and/or a number) of the exemplary disclosed protrusions of adhesive layer 305 and/or by decreasing a depth (e.g., and/or a number) of the exemplary disclosed recesses of adhesive layer 305. An adhesive strength of adhesive material of adhesive layer 305 may be decreased proportionally to increasing the surface area (e.g., the unevenness) of adhesive surface 315. An adhesive strength of adhesive material of adhesive layer 305 may be increased proportionally to decreasing the surface area (e.g., the unevenness) of adhesive surface 315. Also for example, the adhesive strength of adhesive material of adhesive layer 305 and the surface area (e.g., the unevenness) of adhesive surface 315 may both be increased or decreased as desired.

For example, an increase in peeling force based on increasing contact surface area may be substantially equal to a decrease in peeling force due to decreasing tackiness of adhesive material and/or decreasing adhesive strength of adhesive material, which may maintain a substantially constant peeling force (e.g., or the peeling force may be decreased or increased by any desired amount). For example, the increased surface area in contact and adhered between uneven surfaces of adhesive surface 315 and uneven surface 415 may allow for an increase in peeling force without increasing a strength of adhesive material of adhesive layer 305 (e.g., or may allow for a strength of adhesive material of adhesive layer 305 to be decreased while maintaining a substantially same peeling force). By increasing surface contact area (e.g., surface area between uneven surfaces of adhesive surface 315 and uneven surface 415), an aggressiveness of the adhesive material of adhesive layer 305 may be reduced, which may make assembly 100 safer to use and may reduce a probability of adhesive material transfer from adhesive layer 305 to surface portion 400 when assembly 100 is detached from surface portion 400.

FIG. 11 illustrates another exemplary application in which assembly 100 including adhesive layer 305 having adhesive surface 315 that may be uneven may be utilized (e.g., an application in which using an uneven adhesive surface may be beneficial). Adhesive layer 305 may have a rubbery property. Adhesive layer 305 may feel rubbery for example when adhesive layer 305 may be formed from acrylic-based adhesive, rubber-based adhesive, a hotmelt, and/or other suitable materials for example as described herein. Adhesive layer 305 may thereby have a rubbery characteristic after drying in addition to having adhesive surface 315 that may be uneven. Adhesive surface 315 that may be uneven or textured (e.g., as illustrated in FIGS. 2-7) and/or rubbery may provide cushioning for a fragile surface portion 500. For example, adhesive surface 315 that may be uneven (e.g., and that may be rubbery) may provide increased deformation of adhesive layer 305, which may cushion fragile surface portion 500 if force is applied to assembly 100. Fragile surface portion 500 may be any suitable fragile material such as glass, surfaces of artifacts or objects of historical value (e.g., surfaces of historical landmarks or surfaces of archeological work locations), artwork, sculptural works, and/or any other suitable surface portions of fragile or valuable objects or structures.

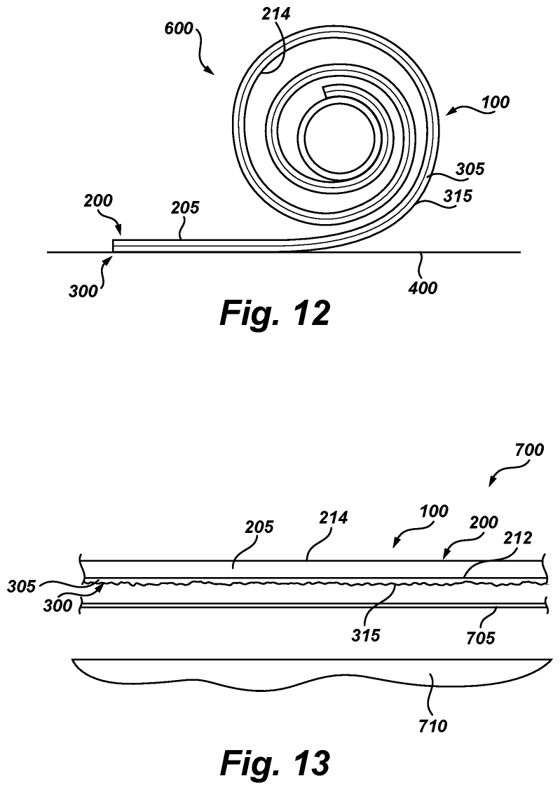

FIG. 12 illustrates another exemplary application in which assembly 100 including adhesive layer 305 having adhesive surface 315 that may be uneven may be utilized (e.g., an application in which using an uneven adhesive surface may be beneficial). Assembly 100 may form part of a self-wound film 600 such as a self-wound protective adhesive film. Self-wound film 600 may be wrapped or wound so that adhesive surface 315 faces outward. For example as illustrated in FIG. 12, self-wound film 600 may be wound without a liner (e.g., without cover layer 310) so that adhesive surface 315 that may be uneven may be removably adhered to opposite surface 214. Adhesive surface 315 that may be uneven (e.g., textured) may reduce a contact surface area between adhesive surface 315 and opposite surface 214 that may be a smooth or flat surface (e.g., and not an uneven surface). The reduced surface area in contact between adhesive surface 315 that may be uneven and opposite surface 214 that may be smooth or flat may reduce a peeling force for separating adhesive surface 315 from opposite surface 214, which may make it easier for a user to unwind self-wound film 600.

FIG. 13 illustrates another exemplary application in which assembly 100 including adhesive layer 305 having adhesive surface 315 that may be uneven may be utilized (e.g., an application in which using an uneven adhesive surface may be beneficial). Assembly 100 may be utilized with a transfer system 700 including a transfer tape 705 (e.g., a premask tape) and a transfer surface portion 710. Opposite surface 214 of film layer 205 may include an image portion such as graphics (e.g., vinyl graphics) or a decal. Adhesive surface 315 may be uneven and transfer tape 705 may have smooth or flat surface, which may reduce an adhered surface contact area between adhesive surface 315 and transfer tape 305 and may make it relatively easy to remove adhesive surface 315 from transfer tape 305. This may make transferring assembly 100 that may include graphics or a decal from transfer tape 705 easier prior to attaching assembly 100 by adhering adhesive surface 315 to transfer surface portion 710. This may also avoid involving embossing of the exemplary disclosed surfaces (e.g., film surface 212), as adhesive surface 315 that may be uneven may provide the uneven surface that embossing may provide.

In at least some exemplary embodiments and as described for example herein, the exemplary disclosed adhesive layer may be deliberately made uneven (e.g., deliberately unsmoothed or textured) to increase a contact surface area between the uneven adhesive layer and an uneven or irregular surface to be protected. Increasing the contact surface area for example as described herein may allow for a peeling force between the adhesive layer and the surface to be protected to be increased or for an adhesive strength of the adhesive material of the adhesive layer to be reduced while maintaining a substantially constant peeling force based on the increased contact surface area.

The exemplary disclosed system, apparatus, and method may be used in any suitable application for protecting a surface. For example, the exemplary disclosed system, apparatus, and method may be used for protecting an uneven surface. The exemplary disclosed system, apparatus, and method may be used for protecting a rug or carpet. The exemplary disclosed system, apparatus, and method may be used for protecting fragile surfaces. The exemplary disclosed system, apparatus, and method may be used in any suitable application in which a substrate is to be easily removed from an adhesive surface. The exemplary disclosed system, apparatus, and method may be used in any suitable application in which a layer or film is unwound. In at least some exemplary embodiments, the exemplary disclosed system, apparatus, and method may be used for labels, instructions (e.g., instructions labels) applied to fabrics, providing insulation properties between laminates, and/or gluing films or layers (e.g., Tyvek) to uneven or porous surfaces in construction applications.

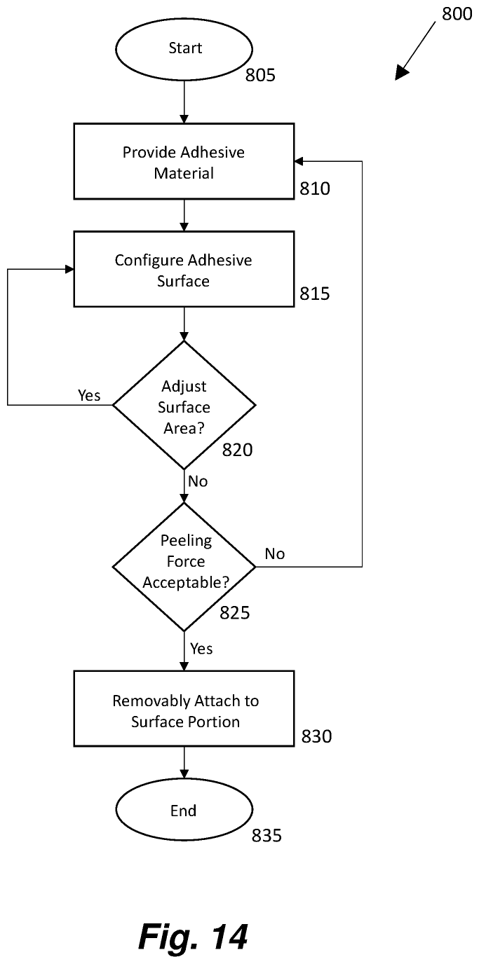

FIG. 14 illustrates an exemplary operation for using exemplary disclosed assembly 100. Process 800 begins at step 805. At step 810, the exemplary disclosed adhesive material of adhesive layer 305 may be provided on film surface 212 of protective assembly 200. In at least some exemplary embodiments, the exemplary disclosed adhesive material of adhesive layer 305 may be provided on film surface 212 in liquid form and may be diluted with a diluent (e.g., water and/or solvent). The exemplary disclosed adhesive material of adhesive layer 305 may be dried after being applied on film surface 212.

At step 815, adhesive layer 305 may be configured. Adhesive surface 315 may be provided for example as described herein. For example, adhesive surface 315 may be provided as illustrated in FIGS. 2-7. Adhesive surface 315 may be provided based on the exemplary disclosed adhesive material having relatively high surface tension properties (e.g., via portions such as beads being formed by de-wetting, foaming, bubbling, or any other suitable technique), via spreading device 335 for example as illustrated in FIG. 9 and/or by any other suitable technique. Adhesive surface 315 may be provided with an uneven surface for example as described herein.

At step 820, it may be determined that the exemplary disclosed surface area of adhesive surface 315 is to be adjusted. For example, it may be determined that the exemplary disclosed surface area of adhesive surface 315 should be increased to increase a peeling force or to compensate for adhesion material of adhesive layer 305 having lower adhesion strength (e.g., or surface area may be decreased). If the surface area is to be adjusted (e.g., increased or decreased), process 800 returns to step 815. If surface area is not to be adjusted, process 800 proceeds to step 825.

At step 825, the peeling force may be determined as acceptable or unacceptable. The peeling force may be determined (e.g., calculated or estimated) based on the surface area of adhesive surface 315 and an adhesive strength of adhesive material of adhesive layer 305. If the peeling force is not acceptable, process 800 returns to step 810. Steps 810, 815, 820, and 825 may be iteratively repeated as desired. If the peeling force is determined as acceptable, process 800 proceeds to step 830.

At step 830, assembly 100 may be removably attached (e.g., or permanently attached) to surface portion 400 for example as described above. Assembly 100 may also be attached to fragile surface portion 500 for example as described above. Assembly 100 may further be attached to transfer tape 705 and transfer surface portion 710 for example as described above. Process 800 ends at step 835.

In at least some exemplary embodiments, the exemplary disclosed system, apparatus, and method may provide an adhesive layer to the surface of a protective layer so that the adhesive layer may be uneven. This may be achieved by forming an adhesive layer from liquid adhesive material having a surface tension that is slightly greater than a surface wet tension of the adhesive layer, thus forming some beading at the adhesive surface while still providing wetting (e.g., substantially total wetting) of the protective layer, which may produce a textured pattern in the adhesive layer.

In at least some exemplary embodiments, the exemplary disclosed system, apparatus, and method may provide for protecting or bonding to a surface portion having an uneven surface. The apparatus may include a protective layer and an adhesive layer having a first surface that may be permanently adhered to a base surface of the protective layer. A second surface of the adhesive layer, which may be disposed on an opposite side of the adhesive layer as the first surface, may be an uneven adhesive surface configured to removably or permanently attach to the uneven surface of the surface portion.

In at least some exemplary embodiments, the exemplary disclosed method may be a method for protecting a surface portion and may include providing an adhesive layer (e.g., adhesive layer 305) on a surface of a protective layer, the adhesive layer having a first surface that is adhered to the surface of the protective layer, providing an uneven second surface (e.g., adhesive surface 315) to the adhesive layer, the uneven second surface disposed on an opposite side of the adhesive layer as the first surface, and attaching the protective layer to the surface portion by attaching the uneven second surface of the adhesive layer to an uneven surface of the surface portion. Providing the uneven second surface to the adhesive layer may include de-wetting the adhesive layer at the surface of the protective layer. Providing the uneven second surface to the adhesive layer may include forming the adhesive layer from adhesive material having a surface tension that is greater than a surface energy (e.g., a wet surface tension) of the surface of the protective layer. Providing the uneven second surface to the adhesive layer may include forming the adhesive layer from adhesive material having a surface tension that is between 1 dyne/cm and 4 dynes/cm greater than a wet surface tension of the protective layer. Providing the uneven second surface to the adhesive layer may include providing a plurality of recesses and protrusions to the adhesive layer. The surface portion may be a carpet or a rug. Attaching the uneven second surface of the adhesive layer to the uneven surface of the carpet or the rug may include deforming a plurality of fibers of the carpet or the rug in a plurality of recesses and against a plurality of protrusions forming the uneven second surface of the adhesive layer. Attaching the protective layer to the surface portion may include removably attaching the uneven second surface of the adhesive layer to the uneven surface of the surface portion. The surface portion may be formed from at least one material selected from the group of glass, crystal, porcelain, marble, and combinations thereof (e.g., and/or any other easily fractured material). The exemplary disclosed method may also include increasing a surface area of the uneven second surface by increasing an amount of recesses and protrusions provided in the adhesive layer. The exemplary disclosed method may further include decreasing an adhesive strength of adhesive material of the adhesive layer proportionally to increasing the surface area of the uneven second surface. The exemplary disclosed method may also include detaching the uneven second surface of the adhesive layer from a transfer tape before attaching the uneven second surface of the adhesive layer to the uneven surface of the surface portion, wherein the protective layer includes vinyl graphics or a decal. Providing the uneven second surface to the adhesive layer may include carving material out of the adhesive layer. Providing the uneven second surface to the adhesive layer may include applying adhesive material of the adhesive layer to the surface of the protective layer using a gravure roller.

In at least some exemplary embodiments, the exemplary disclosed apparatus may be for protecting a surface portion having an uneven surface and may include a protective layer and an adhesive layer having a first surface that is permanently adhered to a base surface of the protective layer. A second surface of the adhesive layer, which may be disposed on an opposite side of the adhesive layer as the first surface, may be an uneven adhesive surface configured to removably attach to the uneven surface of the surface portion. The adhesive layer may be formed from adhesive material having a surface tension that is greater than a surface energy of the base surface of the protective layer. The surface tension may be between 40 dynes/cm and 50 dynes/cm. The adhesive layer may be rolled as a self-wound roll in which a protective surface of the protective layer, which may be disposed on an opposite side of the protective layer as the base surface, removably adheres to the uneven adhesive surface. The exemplary disclosed apparatus may also include a cover layer that may be removably attached to the uneven adhesive surface.

In at least some exemplary embodiments, the exemplary disclosed method may be a method for protecting a surface portion and may include providing an adhesive layer on a surface of a protective layer, the adhesive layer having a first surface that is adhered to the surface of the protective layer, providing an uneven second surface to the adhesive layer, the uneven second surface disposed on an opposite side of the adhesive layer as the first surface, attaching the protective layer to the surface portion by attaching the uneven second surface of the adhesive layer to an uneven surface of the surface portion, increasing a surface area of the uneven second surface by increasing an unevenness of the uneven second surface, and decreasing an adhesive strength of adhesive material of the adhesive layer proportionally to increasing the surface area of the uneven second surface. Increasing the unevenness of the uneven second surface may include at least one selected from the group of increasing a height of a plurality of protrusions of the adhesive layer, increasing a number of the plurality of protrusions of the adhesive layer, increasing a depth of a plurality of recesses of the adhesive layer, increasing a number of the plurality of recesses of the adhesive layer, and combinations thereof. Decreasing the adhesive strength of adhesive material of the adhesive layer proportionally to increasing the surface area of the uneven second surface may include maintaining a substantially constant peeling force between the adhesive layer and the surface portion as the adhesive strength is decreased and the surface area is increased.

In at least some exemplary embodiments, the exemplary disclosed system, apparatus, and method may provide an efficient and effective system for providing a surface protection film for uneven surfaces. For example, the exemplary disclosed system, apparatus, and method may provide a relatively inexpensive surface protection film for uneven surfaces (e.g., carpets and rugs). The exemplary disclosed system, apparatus, and method may also substantially prevent adhesive transfer between a surface protection film and an uneven surface to be protected.

It will be apparent to those skilled in the art that various modifications and variations can be made to the exemplary disclosed system, apparatus, and method. Other embodiments will be apparent to those skilled in the art from consideration of the specification and practice of the exemplary disclosed system, apparatus, and method. It is intended that the specification and examples be considered as exemplary, with a true scope being indicated by the following claims.

What is claimed is:

1. A method for protecting a surface portion, comprising:
providing an adhesive layer on a surface of a protective layer, the adhesive layer having a first surface that is adhered to the surface of the protective layer;
providing an uneven second surface to the adhesive layer, the uneven second surface disposed on an opposite side of the adhesive layer as the first surface; and
attaching the protective layer to the surface portion by attaching the uneven second surface of the adhesive layer to an uneven surface of the surface portion.

2. The method of claim 1, wherein providing the uneven second surface to the adhesive layer includes de-wetting the adhesive layer at the surface of the protective layer.

3. The method of claim 1, wherein providing the uneven second surface to the adhesive layer includes forming the adhesive layer from adhesive material having a surface tension that is greater than a wet surface tension of the protective layer.

4. The method of claim 1, wherein providing the uneven second surface to the adhesive layer includes forming the adhesive layer from adhesive material having a surface tension that is between 1 dyne/cm and 4 dynes/cm greater than a wet surface tension of the protective layer.

5. The method of claim 1, wherein providing the uneven second surface to the adhesive layer includes providing a plurality of recesses and protrusions to the adhesive layer.

6. The method of claim 1, wherein the surface portion is a carpet or a rug.

7. The method of claim 6, wherein attaching the uneven second surface of the adhesive layer to the uneven surface of the carpet or the rug includes deforming a plurality of fibers of the carpet or the rug in a plurality of recesses and against a plurality of protrusions forming the uneven second surface of the adhesive layer.

8. The method of claim 1, wherein attaching the protective layer to the surface portion includes removably attaching the uneven second surface of the adhesive layer to the uneven surface of the surface portion.

9. The method of claim 1, wherein the surface portion is formed from at least one material selected from the group of glass, crystal, porcelain, marble, and combinations thereof.

10. The method of claim 1, further comprising increasing a surface area of the uneven second surface by increasing an amount of recesses and protrusions provided in the adhesive layer.

11. The method of claim 10, further comprising decreasing an adhesive strength of adhesive material of the adhesive layer proportionally to increasing the surface area of the uneven second surface.

12. The method of claim 1, further comprising detaching the uneven second surface of the adhesive layer from a transfer tape before attaching the uneven second surface of the adhesive layer to the uneven surface of the surface portion, wherein the protective layer includes vinyl graphics or a decal.

13. The method of claim 1, wherein providing the uneven second surface to the adhesive layer includes applying adhesive material of the adhesive layer to the surface of the protective layer using a gravure roller.

14. An apparatus for protecting a surface portion having an uneven surface, comprising:
a protective layer; and
an adhesive layer having a first surface that is permanently adhered to a base surface of the protective layer;
wherein a second surface of the adhesive layer, which is disposed on an opposite side of the adhesive layer as the first surface, is an uneven adhesive surface configured to removably attach to the uneven surface of the surface portion; and
wherein the adhesive layer is formed from adhesive material having a surface tension that is greater than a surface energy of the base surface of the protective layer.

15. The apparatus of claim 14, wherein the surface tension is between 30 dynes/cm and 60 dynes/cm.

16. The apparatus of claim 14, wherein the adhesive layer is rolled as a self-wound roll in which a protective surface of the protective layer, which is disposed on an opposite side of the protective layer as the base surface, removably adheres to the uneven adhesive surface.

17. The apparatus of claim 14, further comprising a cover layer that is removably attached to the uneven adhesive surface.

18. A method for protecting a surface portion, comprising:
providing an adhesive layer on a surface of a protective layer, the adhesive layer having a first surface that is adhered to the surface of the protective layer;
providing an uneven second surface to the adhesive layer, the uneven second surface disposed on an opposite side of the adhesive layer as the first surface;
attaching the protective layer to the surface portion by attaching the uneven second surface of the adhesive layer to an uneven surface of the surface portion;
increasing a surface area of the uneven second surface by increasing an unevenness of the uneven second surface; and
decreasing an adhesive strength of adhesive material of the adhesive layer proportionally to increasing the surface area of the uneven second surface.

19. The method of claim 18, wherein increasing the unevenness of the uneven second surface includes at least one selected from the group of increasing a height of a plurality of protrusions of the adhesive layer, increasing a number of the plurality of protrusions of the adhesive layer, increasing a depth of a plurality of recesses of the adhesive layer, increasing a number of the plurality of recesses of the adhesive layer, and combinations thereof.

20. The method of claim 18, wherein decreasing the adhesive strength of adhesive material of the adhesive layer proportionally to increasing the surface area of the uneven second surface includes maintaining a substantially constant peeling force between the adhesive layer and the surface portion as the adhesive strength is decreased and the surface area is increased.
